(19) United States
(12) Patent Application Publication
(10) Pub. No.: US 2018/0158121 A1
(43) Pub. Date: Jun. 7, 2018

(54) DIGITAL CONTENT GENERATION BASED ON ENVIRONMENTAL CONDITIONS

(71) Applicant: INTERNATIONAL BUSINESS MACHINES CORPORATION, Armonk, NY (US)

(72) Inventors: Donna K. BYRON, Petersham, MA (US); Benjamin L. JOHNSON, Baltimore, MD (US); Florian PINEL, New York, NY (US)

(21) Appl. No.: 15/368,850

(22) Filed: Dec. 5, 2016

(51) Int. Cl. G06Q 30/06; H04L 29/08

(52) U.S. Cl. CPC G06Q 30/0605; H04L 67/32

(57) ABSTRACT

A method includes determining an environmental condition and determining that demand for a target data object is below a threshold value under the environmental condition. The method further includes identifying an offering whose demand is above the threshold value under the environmental condition and that includes the target data object. Also, the method includes generating digital content containing the offering and information about the target data object and transmitting the digital content to a user device over a network.

### BACKGROUND

The present disclosure relates to the generation of digital content, and more specifically, to the generation of digital content for presentation to a user for a specified data object, such as a product based, on the correlation of the current environmental condition(s) to the desirability of the data object.

On-line services may generate digital content for transmission to user devices. The digital content may be rendered on the user device and viewed by the user of the user device. The digital content may include a vast assortment of information. The information included in the digital content may include a data object that is relevant to, for example, a particular product or service.

Some types of data objects are desirable to users, but the desirability of some data objects may vary based on one or more environmental conditions. For example, a product such as coconut milk may be in high demand during warm summer months, and the demand may drop significantly during colder winter months. Digital content generated by an on-line service to offer coconut milk may be desirable to a large number of users during the summer but not so during the winter.

### SUMMARY

According to an embodiment of the present invention, a method includes determining an environmental condition and determining that demand for a target data object is below a threshold value under the environmental condition. The method further includes identifying an offering whose demand is above the threshold value under the environmental condition and that includes the target data object. Also, the method includes generating digital content containing the offering and information about the target data object and transmitting the digital content to a user device over a network.

In another embodiment, a system includes one or more compute devices configured to execute an environmental condition determination service, an offering service, and a content creation service. The environmental condition determination service is configured to obtain a current environmental condition. The offering service is configured to identify an offering whose demand is above a threshold value under the current environmental condition, the identified offering including a target product. The content creation service is configured to determine that demand for the target product is below the threshold value under the current environmental condition, generate digital content containing information about the offering and information about the target product and transmit the digital content to a user device over a network

In yet another embodiment, a computer program product for generating digital content includes a computer readable storage medium having program instructions embodied therewith. The program instructions are executable by a computer to cause the computer to determine that demand for a target product is unfavorable under a current environmental condition and identify an offering whose demand is favorable under the current environmental condition and that includes the target product. The instructions also cause the computer to generate digital content containing the offering and information about the target product and transmit the digital content to a user device over a network.

### BRIEF DESCRIPTION OF THE DRAWINGS

FIG. 1 shows a system in accordance with various embodiments for generating digital content;

FIG. 2 shows another embodiment of the digital content generator in accordance with various examples;

FIG. 3 shows an example of a database that maps products and offerings to metadata indicative of environmental conditions in accordance with various embodiments;

FIG. 4 shows a method for determining the correlation between individual products and environmental conditions in accordance with various embodiments;

FIG. 5 shows a method for generating digital content for a given product taking into account the correlation between users' environmental conditions and the product in accordance with various embodiments; and

FIG. 6 shows a computing system in accordance with various embodiments.

### DETAILED DESCRIPTION

As noted above, some data objects may correlate to various environmental conditions. While the example above pertained to the correlation between coconut milk and weather, the disclosed embodiments are directed to any type of data object and any type of environmental condition. Examples of environmental conditions include weather (e.g., weather at the location of the user device), price of a product, service, or commodity (e.g., price of oil or gasoline), geographic location of the user device, time of the year, trends on social media, or other media, sales metrics, marketing metrics, etc. A system is described herein that, for a given data object, determines the current environmental condition associated with possible demand for that object. If the current environmental condition is one that has been deemed to be favorable to the data object, then digital content featuring the data object is generated and transmitted to the user device. However, if the current environmental condition is one that has been deemed to be unfavorable to the data object (e.g., unfavorable to demand for the data object), then digital content featuring an offering that has been determined to be favorable under the current environmental condition is generated and transmitted to the user device. In this latter case, the offering may include the data object that by itself is unfavorable in light of the current environmental condition, but combined with the other components of the offering results in digital content that is determined to likely be desirable to users under the current environmental condition.

In one example, demand for coconut milk may be relatively high during the summer but low during the winter. However, a hot soup (which typically is desirable during the winter) containing coconut milk as an ingredient may be desirable to the users on a cold day. As such, the system determines the environmental condition of relevance to coconut milk (e.g., temperature) and either generates digital content prominently featuring coconut on a hot day or generates a recipe for a coconut milk-based soup on a cold day. Either way, the system generates digital content that has been determined apriori to likely be of interest to a large number of users taking into account each user's environmental condition.

The term “data object” is used herein to identify any type of element of potential interest to users. Examples of data objects include identifications of products, identifications of services, etc. In some embodiments, the element described by a data object may be purchased by a user, but need not be in other embodiments. The term “offering” refers to any type of user device-accessible media object such as a HyperText Markup Language (HTML) object, text, a graphical object, video, audio, etc. that presents information to a user of the user device. Offerings may include data objects or at least information about data objects. In some embodiments, offerings may include one or more data objects that are desirable under the current environmental conditions, one or more data objects that are undesirable, and suggests a way to combine them.

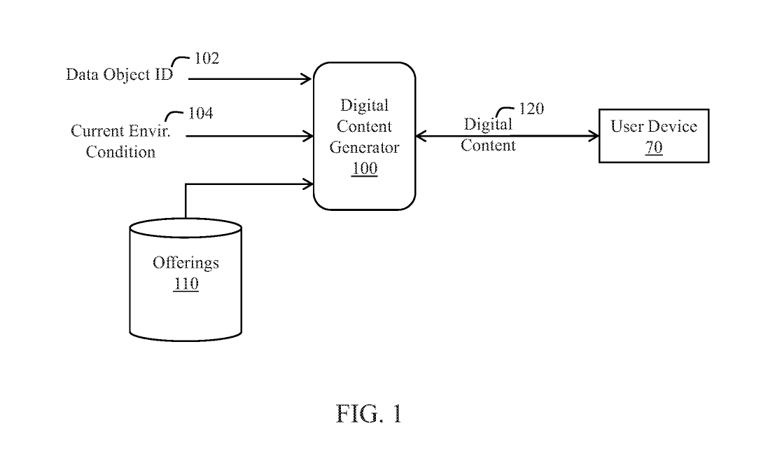

FIG. 1 illustrates an example of a digital content generator 100. In some embodiments, the digital content generator 100 may be implemented as one or more computers (e.g., servers) executing machine instructions that perform the functionality described herein. The digital content generator 100 generates digital content 120 based on inputs including a data object identifier (ID) 102, a current environmental condition 104, and information retrieved from an offerings database 110.

The digital content 120 is generated by the digital content generator 120 to include information pertaining to a data object identified by the data object ID. A unique ID may be assigned to each data object. In some embodiments, the ID is a unique number or other type of alphanumeric character string or a descriptive name of the data object.

The current environmental condition 104 includes one or more environmental indicators that may be relevant to the usefulness for the data object. Examples of environmental conditions include weather conditions such as temperature, precipitation, humidity, etc., average commodity prices (e.g., price of oil, gasoline, etc.), geographic location of a user device 70 that may receive the digital content 120, time of year, trends on social media, etc. Some products, as mentioned above, may be in greater demand in certain weather conditions.

The digital content generator receives the data object ID 102 and then retrieves the current environmental condition 104 that may be relevant to that data object. The offerings database 110 may store records that map data object IDs to environmental conditions. For example, for a given data object that is known to be in higher demand in warm weather than cold weather, the offerings database 110 may include an ID of the data object and metadata that indicates that the data object has a correlation to weather and that specifically, the demand for the data object is greater in warm weather and lower in cooler weather. The metadata may include a temperature threshold value for which the correlation of demand for the data object at temperatures above the temperature threshold value is higher than for temperatures below the threshold value.

The digital content generator 100 uses the data object ID 102 to access the offerings database 110 for the environmental condition that has deemed to be relevant to that particular data object. In the example, temperature is the relevant environmental condition. The digital content generator 100 then retrieves the current temperature as the current environmental condition 104. The digital content generator 100 may submit a request to and environmental condition service such as to a uniform resource locator (URL) or Internet Protocol (IP) address of a weather service. In the case of environmental conditions such as weather, the requested environmental condition may be for the environmental condition associated with the location of a user device 70 to which the digital content is to be generated and provided. The location of the user device 70 may be determined in a variety of ways. For example, the user device may be a portable electronic device such as a smart phone, tablet device, or other type of device that includes a location subsystem such as a global positioning system (GPS) receiver. The user device 70 thus may determine and transmit its location to the digital content generator 100, and the digital content generator 100 may then request the current weather condition (e.g., temperature) from the weather service for the location provided by the user device 70.

The digital content generator 100 compares the current environmental condition (temperature in this example) to the temperature threshold for the data object. If the current temperature is above the temperature threshold (indicative, in this example, of the demand for the data object likely to be high), then the digital content generator 100 generates digital content that prominently features the data object. For example, the digital content may comprise an advertisement for a product that is in high demand in warm weather. If the current temperature is above the temperature threshold for the product, the digital content generator 100 generates an advertisement focused on the product.

On the other hand, if the current temperature in this example is below the temperature threshold (indicative of the demand for the data object likely to be low), then the digital content generator 100 generates different digital content, and digital content that pertains to an offering that has been previously determined to be of significant value in cooler temperatures and that includes the data object. For example, the offering may be for a hot soup recipe. The data object may be coconut milk, which normally does not sell well in colder temperatures. As the temperature is determined to be below the threshold and a hot soup recipe offering (which is higher demand in colder weather) is selected, if the hot soup recipe includes coconut milk, then because users may desire to buy the ingredients to make the hot soup, demand for coconut milk may increase under environmental conditions normally unfavorable to coconut milk.

The offerings database 110 may include identities of offerings as well as metadata. The metadata for each offering may indicate, for example, those environmental conditions favorable to the offering. The digital content generator 100 may access the offerings database to select an offering to use as the basis for the digital content.

The digital content 120 generated by the digital content generator 100 may be, for example, a HyperText Markup Language (HTML) document that includes information about the data object or the offering containing the data object.

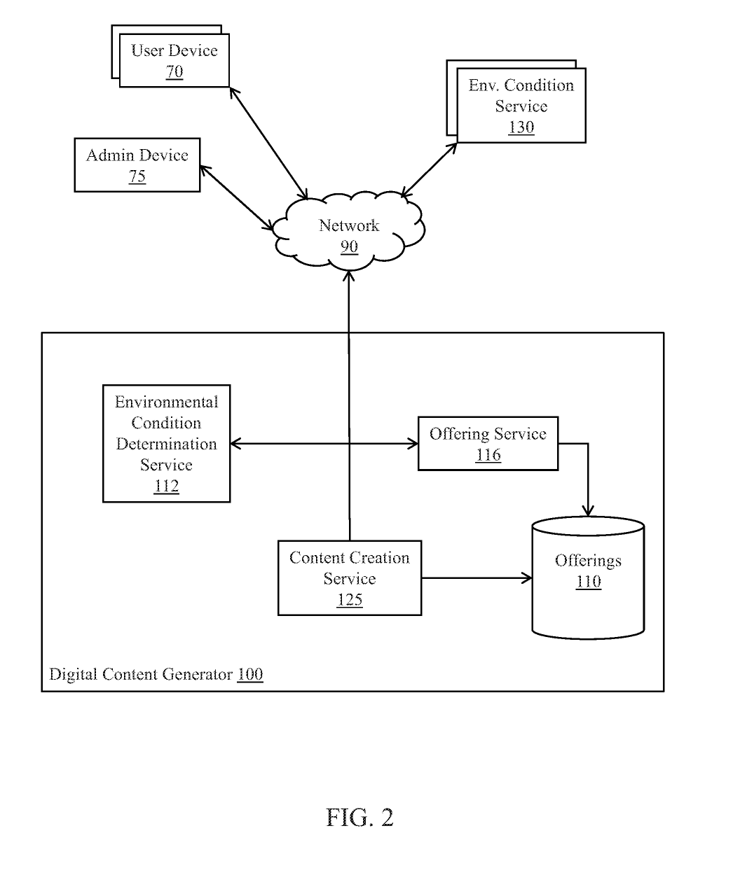

FIG. 2 shows another embodiment of the digital content generator 100. In this example, the digital content generator includes an environmental condition determination service 112, an offering service 116, a content creation service 125, and the offerings database 110. Each of the services 112, 116, and 125 may comprise machine instructions that execute on one or more server computers. In some embodiments, each of the three services comprise three separate servers each executing machine instructions that implements functionality described herein as attributed to each service. In other embodiments, two or more of the services 112, 116, 125 may comprise machine instructions that execute on one server. The breakdown in functionality between the services can be varied from that shown in FIG. 2. For example, in some embodiments, one application program may implement all of the functionality of the digital content generator 100.

The digital content generator 100, and its collection of services 112, 116, 125 may have network connectivity through network 90 to user devices 70 and to one or more environmental condition services 130. Network 90 may be one or more of a public network (e.g., the Internet), local area networks (LANs), wide area networks (WANs), wired or wireless networks, etc. The user devices 70 may comprise personal computers (e.g., desktop computers, notebook computers, etc.), smart phones, tablet devices, personal digital assistants (PDAs), or any other type of computing device that permits a user to interact with the device. The user devices 70 may include one or more hardware processors, memory, non-volatile storage (hard disk drive, solid state storage drive, etc.), network interfaces, etc. and may include an operating system and a network interface application such as a web browser or other type of application. Through the web browser or other type of application, a user can view and interact with digital content generated by the digital content generator.

The environmental condition services 130 may comprise machine instructions executable on servers and accessible the digital content generator 100 via the network 90. Communication packets may be transmitted back and forth between the digital content generator 100 and any of the environmental condition services 130. For example, the environmental condition determination service 112 may submit a request to an environmental condition service 130 for the current weather condition at a particular geographic location such as a request for the current or average temperature at that location. The requested temperature may be for the temperature at that location averaged over the last n days, where n is an integer number of days greater than or equal to 1.

A user may access the digital content generator via a user device 70. The digital content generator may provide, for example, HTML or other types of web pages to a browser executing on the user device 70. The subject matter and purpose of the web pages may be anything of interest to the user. The digital content generator 100 also may digital content pertaining to certain data objects into the web pages for presentation to the user via the user device. The digital content may include text, graphics, video, audio, etc. or a combination of these or other types elements. In one example, the inserted digital content may be for an advertisement of a particular product or offering as noted above. And administrator device 75 may be used to specify information about a data object to be included in the form of digital content generated by the content creation service. Via the administrator device 75, a data object ID may be specified to the content creation service. Further, names and IDs of data objects as well as their descriptions, graphical depictions and other types of information about each data object can be stored in the offerings database 110, or stored in a separate data repository and indexed using index values or pointers included in the offerings database. Thus, the data object ID specified by via an administrator device 75 may be an ID of a record that is already stored in the offerings database 110. The content creation service 125 may generate the digital content as described above based, for example, on whether the relevant current environmental condition provided by an environmental condition service 130 is favorable to the specified data object.

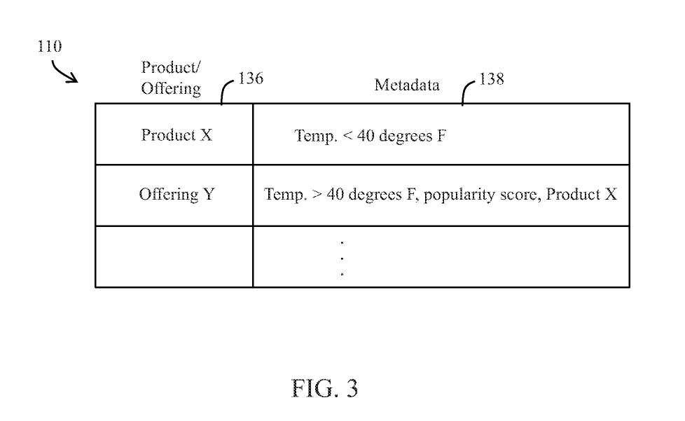

FIG. 3 shows an example of the contents of the offerings database 110. In this example, each record in the database includes an ID 136 of a data object or offering along with metadata 138. The metadata may include an alphanumeric character string, binary values, etc. that specify information about an environmental condition pertaining to the corresponding data object or offering. For example, the metadata may specify an environmental condition that is favorable (or unfavorable) for the data object. In the example of FIG. 3, the metadata for Product X indicates that a temperature below for 40 degrees is favorable in terms of the demand, usability, preference, etc. for Product X. The metadata for Offering Y, on the other hand, indicates that a temperature above 40 degrees is favorable for Offering Y. The Offering Y metadata also includes a reference to Product X indicating that offering Y includes is compatible with, or otherwise relates to Product X. For example, if Offering Y is a soup recipe, Product X may be an ingredient in the recipe, or a category of ingredients in the recipe.

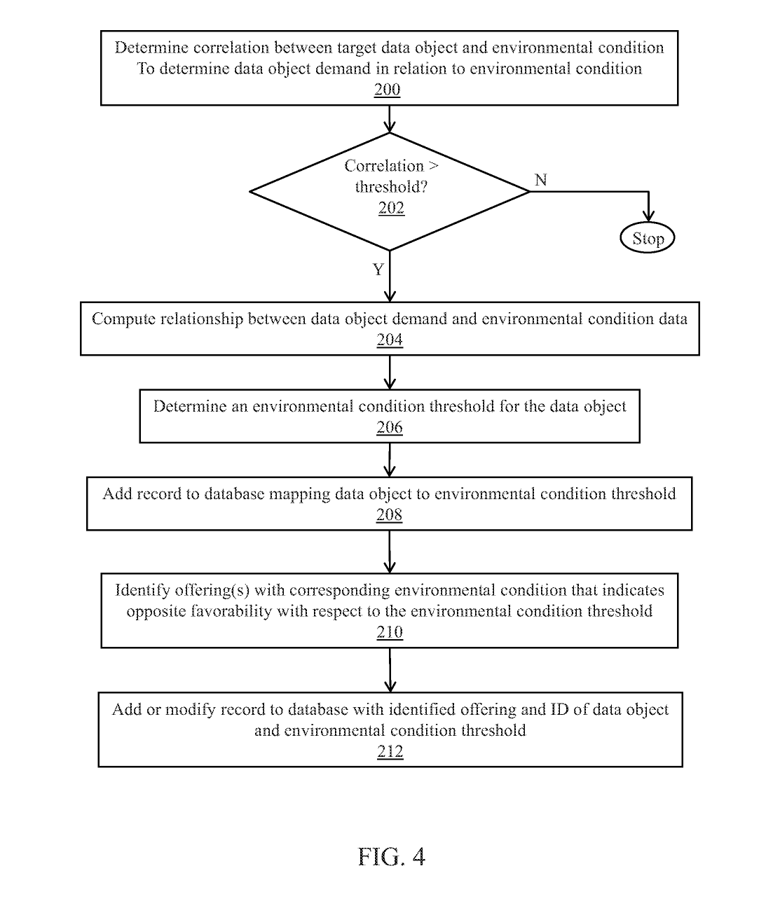

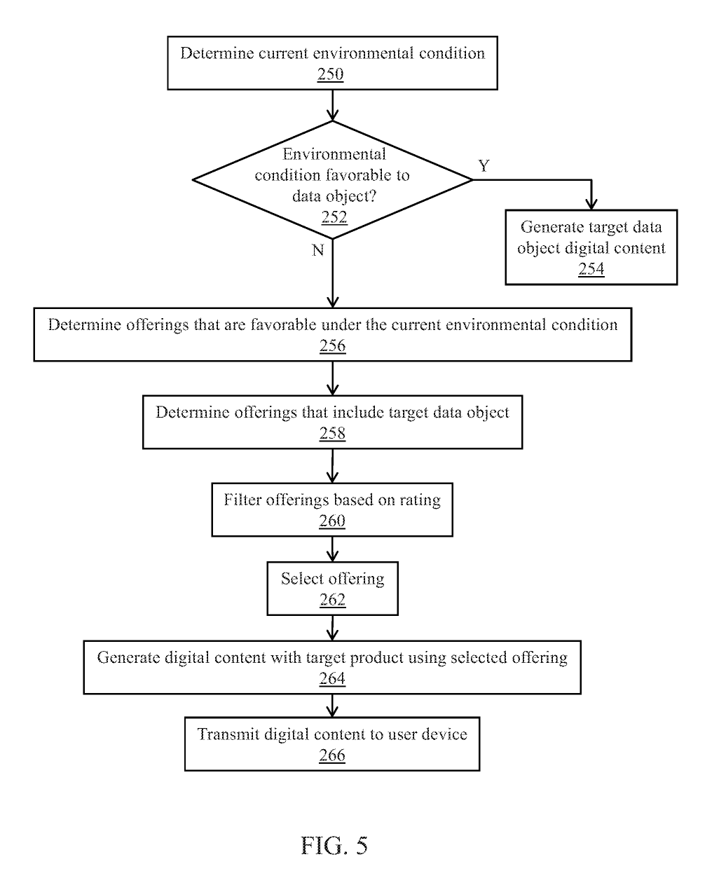

A further explanation of the operation of the digital content generator 100 will now be described with reference to FIG. 2 as well as the method flow charts of FIGS. 4 and 5. FIG. 4 illustrates an embodiment of a method for creating the records that are populated into the offerings database 110. The operations may be performed in the order shown, or in a different order.

At 200, the method includes determining a correlation between a target data object and one or more environmental conditions to determine the demand for the data object in relation to the environmental condition. In one example, this operation may be performed by monitoring the “click rate” for or on the data object and correlating the click rate to one or more environmental conditions. For example, a given data object may be presented to users via user deices 70 in the form of elements (e.g., an advertisement) on a web page. Each time a user selects (clicks via a mouse, touches via a touch screen, etc.) the data object on the web page, a service such as the content creation service 125 records the selection. The content creation service 125 may maintain a counter that counts the number of times and frequency that the data object is selected. The content creation service 125 or the environmental condition determination service 112 also may access one or more environmental conditions from the environmental condition services 130 at, for example, periodic intervals (e.g., once per day). Via an administrator device 75, an administrator indicates one or more environmental conditions that the administrator suspects may correlate positively and/or negatively with the click rate of the data object. The content creation service then determines the click rates over time as well as the various environmental conditions during the same monitored time period. The time period may be ongoing or may be a one or more defined periods of time with start and stop dates and times. Operation 202 may include normalizing the click rate data set and the environmental data set so that they can be correlated.

The content creation service 125, or other service, then may compute a correlation value of the click rate data set with respect to a given environmental condition data set. At 202, the method includes comparing the correlation value to a threshold. In some embodiments, correlation values may be expressed as numbers in the range of 0 to 1, and thus the threshold may be a number in this range. The threshold may be set by an administrator via an administrator device 75 to indicate the level at which a characteristic of a data object (e.g., its demand as ascertained, for example, from its click rate) is deemed to be sufficiently high. The threshold may be set at, for example, a value of 0.75 and thus decision 202 determines whether the correlation value is greater than 0.75.

If the correlation is less than the threshold, as determined at 202, which indicates insufficient correlation, then the process stops. However, if the correlation value is greater than the threshold, then at 204 the method includes computing the relationship between the data object demand and the environmental condition data (e.g., relationship between click rate over time and temperature over the same time period). This operation may comprise performing a statistical analysis such as a linear regression analysis on the click rate data set and the environmental condition data set to compute the relationship between click rate and the environmental condition.

Once the relationship between the data object demand and the environmental condition data is determined, then at 206, the method includes determining an environmental condition threshold for the data object. This operation may be implemented by, for example, an administrator setting the value of the environmental condition threshold upon examination of the data object versus environmental condition relationship. The environmental condition threshold may be a configurable parameter that is input into the content creation service 125. For example, some of the algorithms noted above to calculate the correlation values provide such threshold values (e.g., decision trees).

At 208, the method may include adding a record to a database (e.g., the offerings database 110) to map the target data object to the environmental condition. The record may include metadata, which is indicative of the environmental condition that correlates to the data object (e.g., temperature less than 40 degrees as in the example above). An administrator may generate or otherwise specify the metadata in some embodiments.

The method includes, at 210, identifying offering(s) that have corresponding environmental conditions that indicate opposite favorability with respect to the environmental condition threshold. For example, if the environmental condition threshold is a temperature of 40 degrees and the data object click rate is above the threshold of decision 202 for temperatures above 40 degrees, then an offering is identified determined to be favorable at temperatures below 40 degrees. This operation may be performed by the content creation service 125 performing a search of the offerings database 110 for offerings whose metadata indicates that the offering is favorable for an environmental condition less than environmental condition threshold determined at 206. Further, this operation may include using a search engine to identify those offerings that include or are otherwise associated with the data object. Such search engines may be domain specific (i.e., dependent on the types of data object and offerings). In one example, the search engine may search for metadata associated with offerings for references to the data object. The search engine may include or access an image recognition service to search photographs, video and the like for references to the data object.

At 212, the method includes adding or modifying a record to the database (e.g., the offerings database 110) with the identified offering(s) and IDs of data objects and the environmental condition thresholds. An example of such record is illustrated in FIG. 3.

FIG. 5 illustrates an example of a method in which digital content is generated as described above. The method is performed for a particular data object input, for example, via an administrator device 75. At 250, the method includes determining the current environmental condition. As explained above, this operation may be performed by the environmental condition determination service 112 accessing the offerings database 110, or submitting a request to the offering service 116, for an identity of the environmental condition previously determined to sufficiently correlate to the data object. This information may be extracted from the metadata 138 that maps to the data object. The environmental condition determination service 112 then may transmit a request across network 90 to an environmental condition service 130 to request the current state of the environmental condition (e.g., the current temperature). The environmental condition service 130 may return a reply with the requested environmental condition information.

At 252, the method determines whether the current environmental condition is favorable to the data object. For example, if the current temperature is 50 degrees, and the offerings database indicates that the data object has a temperature threshold of equal to or above 40 degrees, then the data object is determined to be likely be viewed favorably (e.g., high demand) under the current environmental condition. Consequently, at 254, the method includes generating target data object digital content directly using the data object, and not an offering that includes the data object. The digital content generated at 254 may be generated by the content creation service 125 and may include an advertisement in the form of, for example, an HTML object within a web page. The digital content may be selected from a collection of preformed digital content objects stored in a data repository (not shown) accessible to the content creation service 125.

If, however, the current environmental condition is not favorable (per 252) to the data object, then at 256 the method may include determining offerings that are favorable under the current environmental condition. Such offerings may be determined by the offering service 116 accessing the offerings database 110 and performing a search of offerings whose metadata indicates favorability under the current environmental condition.

At this point, offerings have been identified that are favorable under the current environmental condition, but one or more of such offerings may not include the data object of interest. Thus, at 258 the method includes determining offerings from those determined at 256 that include the data object. This determination may be made by searching the metadata of the offerings for the ID or other parameter indicative of the data object.

At 260, the method may include filtering the offerings resulting from 258 based on a rating. The offerings from operation 258 may be favorable under the current environmental condition and may have a relationship to target data object, but it is possible that one or more of the offerings are of little value to users. A rating value may be previously computed for or otherwise assigned to each offering. The rating may be based on user feedback such as click rates of the offering during previous presentations of the offering on user devices. Higher click rates may result in a higher rating value. In some embodiments, a rating threshold may be configured into the content creation service 125 which excludes offerings whose ratings fall below the rating threshold. Thus, filtering the offerings resulting from 258 may result in a set of offerings that are smaller in number than the offerings resulting from 258. In some embodiments, the method may include the digital content generator receiving a feedback indicator for the digital content (generated and transmitted at 264 and 266 as described below) and updating a database record (e.g., in the offerings database 110) for the offering using the feedback indicator. At 262, the content creation service 125 selects the offering from the one or more offerings resulting from 260. If multiple offerings result from 260, then the content creation service may randomly select one of them.

The selected offering is then used by the content creation service 125 to generate digital content. In some embodiments, the digital content may be a web page that causes a visual depiction of the offering to be rendered by a browser executing on a user device 70. The visual depiction may prominently feature the offering, and the offering, as noted above, includes a reference to the target data object. In accordance with an example described above, the visual depiction in the digital content may include a recipe for a hot soup which is created on a cold day (environmental condition favorable to the soup recipe offering), and the recipe includes coconut milk as an ingredient (coconut milk by itself may otherwise be in low demand on cold days). Finally, the digital content is transmitted by the content creation service 125 across the network 90 to the user device 70.

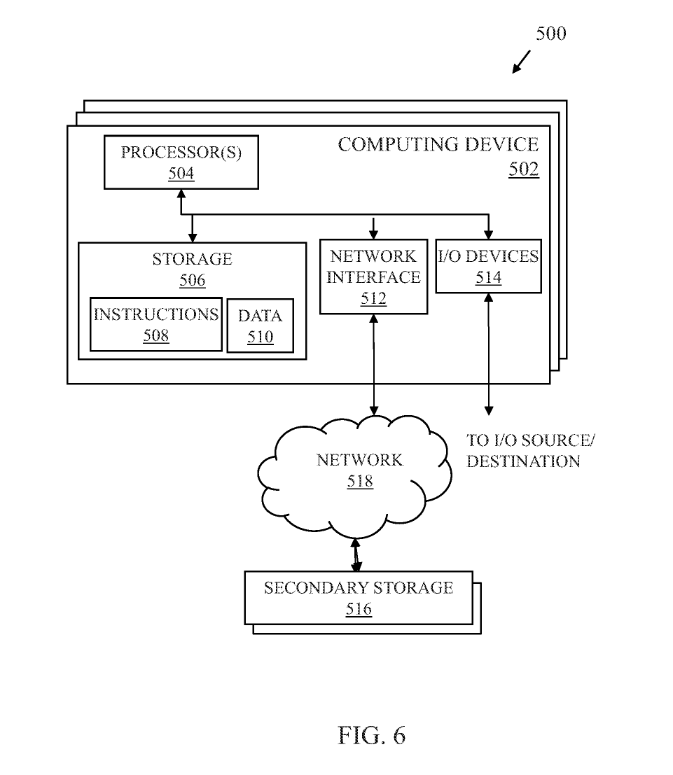

FIG. 6 shows a schematic diagram for a computing system 500 suitable for implementation of the digital content generator 100 including, for example, the environmental condition determination service 112, the offering service 116, and the content creation service as well as the various databases (e.g., offerings database 110) and other services and devices such as the user devices 70, the administrator devices 75 and the environmental condition services 130 in accordance with various embodiments. The system includes one or more computing devices 502. The computing system 500 includes the computing devices 502 and secondary storage 516 communicatively coupled together via a network 518. One or more of the computing devices 502 and associated secondary storage 516 may be used to provide the functionality of the various services, devices, and databases described herein.

Each computing device 502 includes one or more processors 504 coupled to a storage device 506, network interface 512, and I/O devices 514. In some embodiments, a computing device 502 may implement the functionality of more than one component of the system 100. In various embodiments, a computing device 502 may be a uniprocessor system including one processor 504, or a multiprocessor system including several processors 504 (e.g., two, four, eight, or another suitable number). Processors 504 may be any suitable processor capable of executing instructions. For example, in various embodiments, processors 504 may be general-purpose or embedded microprocessors implementing any of a variety of instruction set architectures (“ISAs”), such as the ×86, PowerPC, SPARC, or MIPS ISAs, or any other suitable ISA. In multiprocessor systems, each of processors 504 may, but not necessarily, commonly implement the same ISA. Similarly, each of the computing devices 502 may implement the same ISA, or individual computing nodes and/or replica groups of nodes may implement different ISAs.

The storage device 506 may include a non-transitory, computer-readable storage device configured to store program instructions 508 and/or data 510 accessible by processor(s) 504. The storage device 506 also may be used to store the machine images as explained above. The storage device 506 may be implemented using any suitable volatile memory (e.g., random access memory), non-volatile storage (magnetic storage such as a hard disk drive, optical storage, solid storage, etc.). Program instructions 508 and data 510 implementing the functionality disclosed herein are stored within storage device 506. For example, instructions 508 may include instructions that when executed by processor(s) 504 implement the various services and/or other components of the service provider's network disclosed herein.

Secondary storage 516 may include additional volatile or non-volatile storage and storage devices for storing information such as program instructions and/or data as described herein for implementing the various aspects of the service provider's network described herein. The secondary storage 516 may include various types of computer-readable media accessible by the computing devices 502 via the network 518. A computer-readable medium may include storage media or memory media such as semiconductor storage, magnetic or optical media, e.g., disk or CD/DVD-ROM, or other storage technologies. Program instructions and data stored on the secondary storage 516 may be transmitted to a computing device 502 for execution by a processor 504 by transmission media or signals via the network 518, which may be a wired or wireless network or a combination thereof. Each of the interactive content generator 100, the script generator 110, and the digital content generator 120 as well as the various databases and other components described herein may be implemented as a separate computing device 502 executing software to provide the computing node with the functionality described herein. In some embodiments, some or all of the various services may be implemented by the same computing device.

The network interface 512 may be configured to allow data to be exchanged between computing devices 502 and/or other devices coupled to the network 518 (such as other computer systems, communication devices, input/output devices, or external storage devices). The network interface 512 may support communication via wired or wireless data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 514 may include one or more display terminals, keyboards, keypads, touchpads, mice, scanning devices, voice or optical recognition devices, or any other devices suitable for entering or retrieving data by one or more computing devices 502. Multiple input/output devices 514 may be present in a computing device 502 or may be distributed on various computing devices 502 of the system 500. In some embodiments, similar input/output devices may be separate from computing device 502 and may interact with one or more computing devices 502 of the system 500 through a wired or wireless connection, such as over network interface 512.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining an environmental condition through access to environmental condition service over a network;
determining that demand for a target data object is below a threshold value under the environmental condition;
identifying an offering whose demand is above the threshold value under the environmental condition and that is associated with the target data object; and
generating digital content containing the offering and information about the target data object; and
transmitting the digital content to a user device over a network.

2. The computer-implemented method of claim 1, wherein identifying the offering includes identifying a first plurality of offerings, each offering having a demand that is above the threshold value under the environmental condition and that includes the target data object, and wherein the method further includes filtering the first plurality of offerings using a rating value to produce a second plurality of offerings that are smaller in number than the first plurality of offerings.

3. The computer-implemented method of claim 2 further including selecting an offering from the second plurality of offerings to use in generating the digital content.

4. The computer-implemented method of claim 1 further including receiving a feedback indicator for the transmitted digital content and updating a database record for the offering using the feedback indicator.

5. The computer-implemented method of claim 1, wherein the environmental condition includes a value indicative of at least one of: weather, a geographic location, a time of year, a social media trend, and a price of a product or a service.

6. The computer-implemented method of claim 1, wherein determining the environmental condition includes submitting a request packet over a network to a service for the environmental condition.

7. The computer-implemented method of claim 1, wherein the target data object has an identifier and wherein identifying the offering that includes the target data object comprise performing a search of a plurality of offerings for the target product identifier.

8. The computer-implemented method of claim 1, wherein the target data object includes a product.

9. A system comprising:
one or more compute devices configured to execute an environmental condition determination service, an offering service, and a content creation service;
wherein the environmental condition determination service is configured to obtain a current environmental condition;
wherein the offering service is configured to identify an offering whose demand is above a threshold value under the current environmental condition, the identified offering including a target product; and
wherein the content creation service is configured to determine that demand for the target product is below the threshold value under the current environmental condition, generate digital content containing information about the offering and information about the target product, and transmit the digital content to a user device over a network.

10. The system of claim 9, wherein:
the offering service is configured identify a first plurality of offerings whose demand is each above the threshold value under the environmental condition and that includes the target product;
the content creation service is configured to filter the first plurality of offerings using a rating value to produce a second plurality of offerings that are smaller in number than the first plurality of offerings.

11. The system of claim 10 wherein the content creation service is configured to select an offering from the second plurality of offerings to use for the generation of the digital content.

12. The system of claim 9 wherein the content creation service is configured to update a database record for the offering to reflect a feedback indicator pertaining to the offering.

13. The system of claim 9, wherein the environmental condition includes a value indicative of at least one of: weather, a geographic location, and a price of a product or a service.

14. The system of claim 9, wherein determining the environmental condition includes submitting a request packet over a network to a service for the environmental condition.

15. The system of claim 9, wherein the target product has an identifier and wherein identifying the offering that includes the target product comprise performing a search of a plurality of offerings for the target product identifier.

16. A computer program product for generating digital content, the computer program product comprising a computer readable storage medium having program instructions embodied therewith, the program instructions executable by a computer to cause the computer to:
determine that demand for a target product is unfavorable under a current environmental condition;
identify an offering whose demand is favorable under the current environmental condition and that includes the target product; and
generate digital content containing the offering and information about the target product; and
transmit the digital content to a user device over a network.

17. The computer program product of claim 16, wherein the program instructions further cause the computer to access a database to identify an environmental condition mapped to the target product and transmit a request across a network to obtain the current environmental condition.

18. The computer program product of claim 16, wherein the program instructions further cause the computer to identify the offering through identification of a first plurality of offerings, each offering having a demand that is above the threshold value under the environmental condition and that includes the target product.

19. The computer program product of claim 18, wherein the program instructions further cause the computer to filter the first plurality of offerings using a rating value to produce a second plurality of offerings that are smaller in number than the first plurality of offerings.

20. The computer program product of claim 16, wherein the digital content is a web page.
